(19) United States
(12) Patent Application Publication
(10) Pub. No.: US 2006/0064648 A1
(43) Pub. Date: Mar. 23, 2006

(54) Display module, a device, a computer software product and a method for a user interface view

(75) Inventor: Mikko Makela, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/229,384

(22) Filed: Sep. 15, 2005

(30) Foreign Application Priority Data
Sep. 16, 2004 (FI) 20045344

(51) Int. Cl. G06F 3/00

(52) U.S. Cl. 715/808

(57) ABSTRACT

This invention relates to browsing web pages with a mobile device and especially to a display module, which comprises a user interface view, which comprises at least one link to another user interface view as well as a pointer for selecting said link. The link is arranged to execute a pop-up view in said user interface view and that said same link is in addition arranged to execute one other user interface view in the display module. According to the invention, instead of executing said one other user interface view the link in question is transferred to the pop-up view being opened as a selectable function. Further, the invention relates to a device, a method and a computer software product.

### CROSS-REFERENCE TO RELATED APPLICATIONS

This application claims priority under 35 USC §119 to Finnish Patent Application No. 20045344 filed on Sep. 16, 2004.

### FIELD OF THE INVENTION

The present invention relates to a display module, which comprises a user interface view, which includes at least one link to another user interface view. This invention also relates to a device, which comprises a pointer controller and a display, which display comprises a user interface view, which comprises at least one link to another user interface view. In addition, this invention relates to a computer software product as well as a method for displaying a user interface view.

### BACKGROUND OF THE INVENTION

Web page browser support can already be found in several mobile devices, such as mobile phones, e.g. the Nokia 6620 phone of the Series 60. The most part of the contents of web pages are designed to be used on the displays of computers or the like, which is why adapting them to, e.g., the display of a mobile phone can impair usability. Designing a user interface of a web page browser for the display of a mobile device becomes challenging e.g. when the web page comprises a great deal of contents and different functionalities.

It is possible to connect sub-pages to a web page, which are accessed via so-called links. This kind of link can function, for example, in such a manner that the sub-page that the link points to is opened by clicking the link. A functionality widely used on web pages is the so-called pop-up menu, which is implemented by a mark-up language, such as JavaScript/Jscript. Browsing this kind of a menu is possible by taking the pointer over the pop-up menu comprising a link, but not clicking the link, in which case the pop-up menu in question is opened. An example of this kind of an arrangement is shown in FIG. 1. The figure shows a user interface view 100, which comprises a link bar 110. The figure shows a situation, where the pointer has been taken over the link LINK3 113, in which case a pop-up menu 120 is opened by the link in question. This pop-up menu 120 further comprises sub-links SL1 to SL5, and the pointer has been taken over one SL4 124 of them with the outcome that a new pop-up menu 130 is opened. The links L1 to L7 comprised by this pop-up menu 130 are such that one of them must be clicked in order to open a new user interface view. In connection with this it is to be noted that also the links of other pop-up menus (LINK1 to LINK5, SL1 to SL5) are possible to be clicked, in which case they execute a new user interface view. In other words, said links comprise two functionalities; the function caused by the clicking and the function caused by the pointing. This kind of web page menus are very typical, because they improve the web page usability. By means of this kind of link structures the user can, if desired, avoid browsing the other contents by viewing only the most important points and by accessing the desired target more easily.

The menus described above are well suited for those devices that the user interface type in question has been designed for. Such devices typically comprise a fairly large display as well as a pointer with a button, such as a mouse or a joystick. In mobile devices, such as mobile phones, which do not comprise a pointer device, a mouse, a pen, etc., but which comprise a keyboard and a display, the use of pop-up menus is difficult. It is not possible to open the menu automatically when the user travels towards the link in question with, for example, the arrow keys. When pursuing this link, the user must travel via other links (preceding the link in question). In this kind of a case the pop-up menus opening automatically from focusing would cause the opening of menus even though the user would not want this. The limited scope of the display may also cause problems, because in some cases one menu level may be even larger than the display of the mobile device in question.

In such mobile devices, e.g. PDA devices, which comprise a pen user interface, it may be difficult to open a pop-up menu only by focusing on them, but not by tapping them. This type of focusing would require another type of interaction, such as a long tap or sliding the pen pointer over the link. These interaction types can, however, already be reserved for other uses, such as opening a menu of the device, e.g., for storing images (cf. menu that opens when clicking the other button of a mouse in a Windows operating system) or for scrolling the display (sliding the pen over the display may be used for scrolling the display or for moving files). If this kind of “reserved” interaction methods are also used for focusing on a link, the user interface may become vague.

In addition to these pure pop-up menus such links that comprise two functionalities make the web browsing taking place in a mobile device even more challenging. If a click would open a pop-up menu, loading the link in question would be impossible to begin. Therefore, it can be detected that prior art lacks such a solution, where the browsing of web pages can be implemented with a mobile device in an efficient manner, despite the link types of the web page.

### SUMMARY OF THE INVENTION

The present invention discloses one manner, by means of which the browsing of a web page with an electronic device, such as a mobile device, can be improved in comparison to prior art.

Thus, the display module according to the invention, which comprises a user interface view, which contains at least one link to another user interface view as well as a pointer for selecting said link, which link is arranged to execute a pop-up view in said user interface view and that said same link is, in addition, arranged to execute said other user interface view in the display module, is primarily characterized in that said pop-up view is arranged to be executed instead of executing said other user interface view, which pop-up view comprises the link in question as a selectable function.

The device according to the invention is primarily characterized in that said pop-up view is arranged to be executed instead of executing said other user interface view, which pop-up view comprises the link in question as a selectable function. The computer software product is primarily characterized in that the commands executed with a computer are arranged to implement said pop-up view instead of said other user interface view, as well as to add said link as a selectable function of said pop-up view. The method according to the invention is primarily characterized in that in the method said pop-up view is implemented instead of displaying said other user interface view and the link in question is added as a selectable function of said pop-up view.

In addition, various preferred embodiments of the invention are presented below.

The term user interface view used in the description of the invention refers to that visual information which is shown on the display in question substantially the same as it is. In other words, the user interface view is a representative web site document, which comprises certain attributes and specifications. The user interface view in question may comprise different content as well as links to other user interface views, to other web page documents. In the same user interface view it is possible to also show such dynamic content, for example pop-up windows or pop-up menu, which are later referred to with the term “pop-up view”, which originate from the web page in question. The user interface may also comprise a selection structure (link list), which comprises several targets selectable with a pointer.

The solution according to the invention provides an easy and simple user interface for web pages comprising links. Even though the solution is suitable for all devices enabling browsing of web pages, a simple user interface clearly benefits such devices, which do not comprise multifunctional pointer means, such as a mouse. In addition, the solution according to the invention also supports mobile web page browsers, in which case also web pages displayed by these can be browsed despite the above-described structure.

### DESCRIPTION OF THE DRAWINGS

The present invention will be described in more detail with reference to the appended drawings, in which

FIG. 1 shows an example of a user interface of web pages, which comprises a pop-up menu structure,

FIG. 2 shows an example of a user interface according to the invention for displaying a pop-up menu structure,

FIG. 3 shows an example of a device according to the invention.

### DETAILED DESCRIPTION OF THE INVENTION

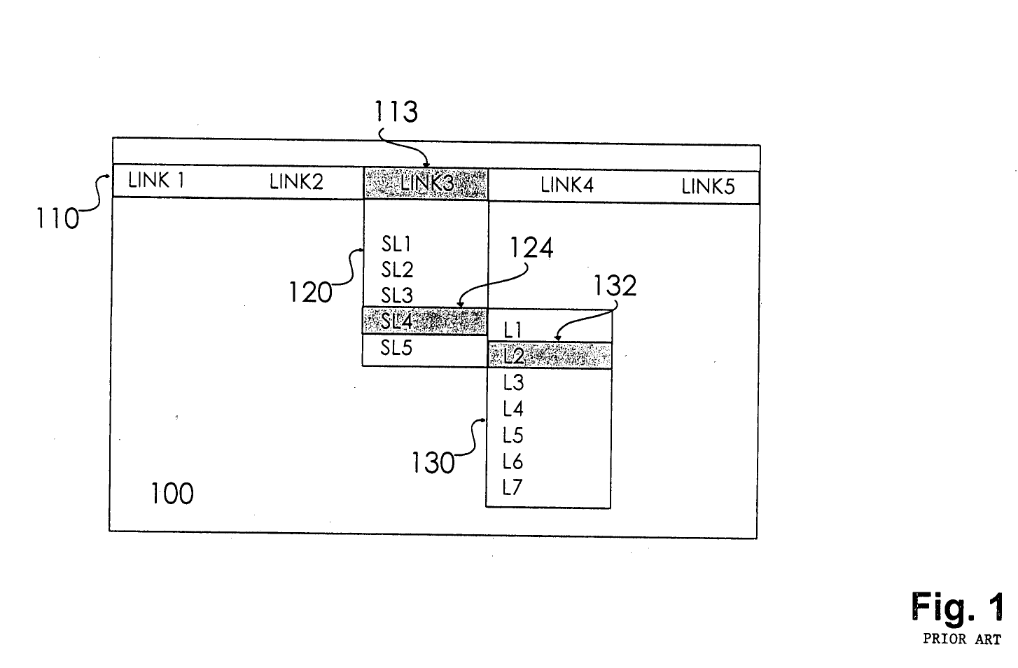

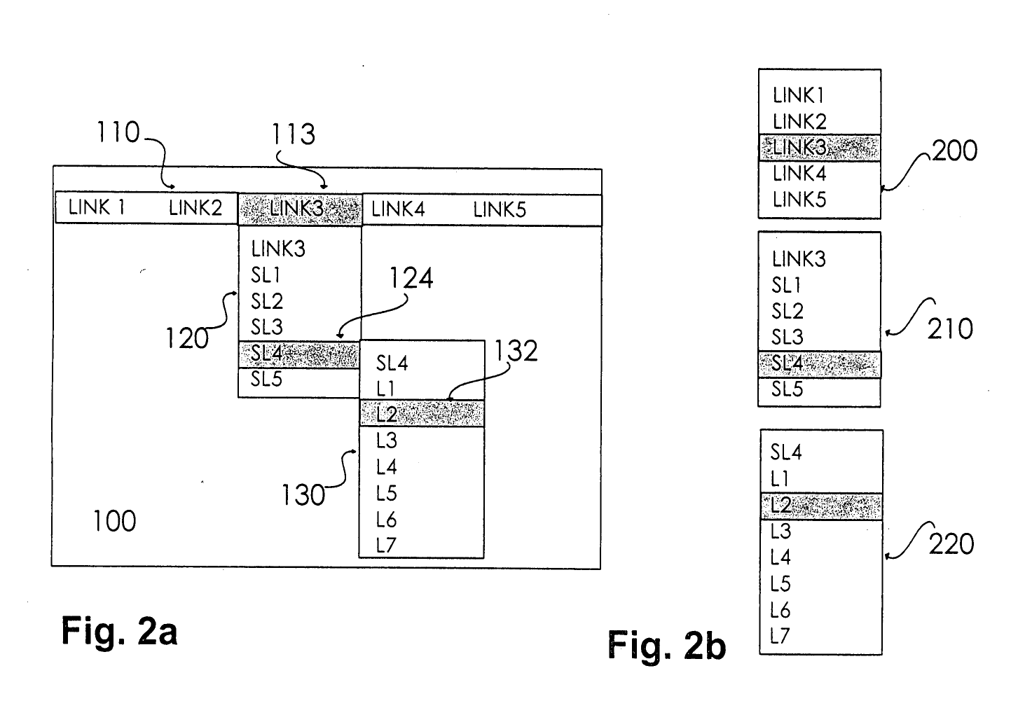

This invention relates to mobile devices, such as mobile phones or PDA devices, and net page browsing taking place in them. The background of the invention section above described prior art problems related to browsing web pages when the browser is a mobile device and especially when there are multifunctional links on a web page. According to the idea of the invention, the above-mentioned problems can be avoided in such a manner that when the user clicks on a link, a focusing event is performed (on-Focus). In the description of the invention the term “click” refers to both pressing a button of a controller, which controller can be, e.g., a mouse or a browser device, such as a mobile device, and also “tapping” (touching) a link with a pen pointer or other touching means. According to the idea of the invention, when a pop-up menu is opened, that link to the web page from which the pop-up menu was opened is added to the beginning of the pop-up menu that has been opened. Thus, for example, the example shown in FIG. 1 would adapt according to FIG. 2a, where the link LINK3 (113) would open a pop-up menu, which comprises sub-links SL1 to SL5, as well as the menu 120 of LINK3 as the first link. The LINK3 can retain its own form in the pop-up menu, but clicking it would load the web page this link points to. Clicking the sub-links of the menu 120 formed in a corresponding manner, when they are double-functional, would execute the opening of a new pop-up menu, to which pop-up menu would be added the sub-link in question. As an example, a sub-link SL4 (124) is drawn in FIG. 2a, clicking which link opens a new pop-up menu 130, which comprises a link SL4 as well as sub-links L1 to L7. In this example these links SL4, L1 to L7 are such that as a result of clicking them the web page corresponding to each is opened. It is to be noted that in the pop-up menus 120, 130 the other links can also be double-functional, such as the links 124, 132 are, or single-functional, in which case clicking them would cause the opening of a new web page.

FIG. 2b shows one further example of a different embodiment of FIG. 2a. FIG. 2b shows such a situation, where the pop-up menu is opened to a separate web page to be displayed. Thus, the first user interface view 200 comprises a first link menu LINK1 to LINK 5, by selecting one of which (LINK3) a new user interface view 210 opens, which comprises the selected link LINK3 as well as the links SL1 to SL5 of the pop-up menu comprised by this. Correspondingly, by clicking on the sub-link SL4, the pop-up menu belonging to this, with the addition of the sub-link SL4 in question, is further opened in the new user interface view 220. In this example, the clicking of other than said links may open a web page with content directly, if no pop-up menu function is connected to them.

It can be detected that by means of this type of an arrangement, it is possible to download all links and their pop-up menu links from a web page in an easy manner, despite the simplicity of the addressing device.

Let us further describe the implementation of the invention by means of the following phases. In a web page browser the content of the web page being loaded is checked and the functionality of a link within it is determined. It is especially checked whether the link can be executed both by focusing on it and by clicking it, and whether the focusing implements simply the opening of a pop-up menu, which pop-up menu displays only the information determined by the mark-up language, and therefore not browser user interface elements, such as frames, button bars, address bars, link bars, etc. After this the execution of a link is implemented in such a manner that only focusing on the link does not execute any functions, but clicking on a link executes those functions that were determined for focusing. Then the link in question is attached to the beginning of the pop-up menu being opened, in which case this link changes into a single-functional one and behaves like any other link in the pop-up menu. Thus, clicking on the link performs the loading of the web page it points to.

Alternatively, it is possible to attach some symbol in connection with the link contained by the pop-up menu to point to the existence of the pop-up menu. This may facilitate the user's functions by demonstrating what can be expected after clicking on a link.

The pop-up menu that has been opened can be shown in its original form, or it can be optimized to the size of the browser view in question.

Above, the invention has been described according to an example, in which the method has been fitted to selection structures. It can, however, be detected that the method according to the invention can be applied in other functions arranged for a web link as well. As an example can be mentioned a so-called “tool-tip”-pop-up window, which opens when a pointer is brought onto a link. This kind of a tool-tip-pop-up window gives further information on the link in question without necessarily containing any selections. Therefore, this kind of a link is double-functional, in which clicking on the link opens the web page that is its target, but focusing on the link opens a pop-up window. Thus, the method according to the invention can be applied in connection with this kind of link in such a manner that clicking on a link executes the opening of a pop-up window and the link in question is attached to the pop-up window that has opened. The link added to this pop-up window has adapted into a single-functional one and can therefore be clicked in order to open the web page. This kind of functionality can also be set as conditional. Thus, it is checked from the pop-up window that opens from the link whether it contains selections. If there are no selections, the web page that is the target of the link is opened directly as a result of the clicking.

The invention can also be expanded in such a manner that the processing of double-functional links is left for the user to decide. It is obvious that this kind of a solution adds the amount of user inputs, but in some situations this type of a function may be useful. Thus, if the link is double-functional (clicking and focusing functions), when the user selects a link, it is inquired whether the clicking or focusing function is to be executed. The function is executed on the basis of the user's answer. In addition, it is possible that the clicking function is determined to be automatically executed, while the focusing function can be selected individually by the user from the menu of the browser device.

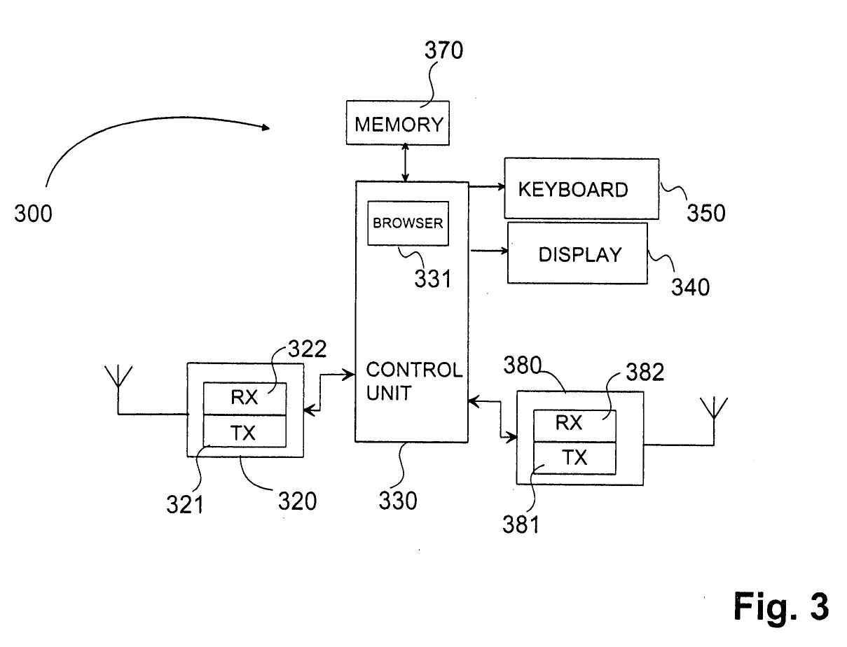

The method according to the invention can be implemented with a program in the desired browser. The browser can be the browser of some electronic device, which comprises at least a data transfer connection. One example of this kind of a device is a mobile phone, an example of which is shown in FIG. 3. Other devices of this kind are, e.g., a PDA device and a portable computer. The device 300 shown in FIG. 3 comprises interaction means, which comprises, e.g., a display 340 and a keyboard 350. The display 340 in question shows the user interface views of web pages and the keyboard 350 in question enables providing user inputs for browsing web pages, for inputting data and for controlling the device. In addition, the device 300 comprises memory 370, to which is stored data, programs, etc. The device 300 further comprises a control unit 330 for controlling the functions of the device 300, which control unit may comprise one or more processors (CPU, DSP). Further, the device 300 comprises a web page browser 331, which is arranged to the control unit 330. Further, the device 300 comprises means 320 for forming a web connection and for receiving web pages with a web browser. These means are formed of a transmitter 321 and a receiver 322. The device 300 may also comprise other data transfer means 380, which contain a transmitter 381 and a receiver 382. The first data transfer means 320 can be arranged for telecommunication and the other data transfer means 380 some known short range data transfer system, such as Bluetooth™, WLAN or some other system, which is suitable for local communication with another device. The device may also comprise other means, e.g. for audio or positioning.

It should, however, be evident for anyone skilled in the art that the user interface views in the examples may vary even greatly, but that the processing of the pop-up links, independent of the view, can be implemented in the manner according to the invention. It is evident that other system, databases or controllers may be connected to the device according to the invention, which facilitate and boost the use of the device.

Thus, the above-presented examples of the invention must not be interpreted as restrictive to the invention, but the embodiments of the invention may be freely varied within the scope of the inventive features presented in the claims hereinbelow.

1. A display module, which comprises a user interface view, which comprises at least one link to another user interface view as well as a pointer for selecting said link, which link is arranged to execute a pop-up view in said user interface view and that said same link is in addition arranged to execute said other user interface view in the display module, wherein said pop-up view is arranged to be executed instead of executing said other user interface view, in which pop-up view the link in question is as a selectable function.

2. The display module according to claim 1, wherein said link is arranged to execute said one other user interface view after the selection executed in the pop-up view.

3. The display module according to claim 1, wherein said pop-up view is arranged to be executed in said one other user interface view.

4. The display module according to claim 1, wherein said link is arranged to be clicked, in which case the pop-up view is executed.

5. The display module according to claim 1, wherein said pop-up view is a pop-up menu, which comprises said link.

6. The display module according to claim 5, wherein the selections of said pop-up menu are arranged to execute at least one other user interface view.

7. A device, which comprises a pointer controller and a display, which display comprises a user interface view, which comprises at least one link to another user interface view as well as a pointer for selecting said link by means of the pointer controller, which link is arranged to execute a pop-up view in said user interface view and that said same link is in addition arranged to execute said other user interface view in the display module, wherein said pop-up view is arranged to be executed instead of executing said other user interface view, in which pop-up view the link in question is as a selectable function.

8. The device according to claim 7, wherein the device is arranged to execute said other user interface view by selecting said link.

9. The device according to claim 7, wherein the device is arranged to execute said pop-up view in said one other user interface view.

10. The device according to claim 7, wherein said link is arranged to be clicked, as a result of which the device is arranged to perform said pop-up view.

11. The device according to claim 7, wherein said pop-up view is a pop-up menu, which comprises said link.

12. The device according to claim 11, wherein the selections of said pop-up menu are arranged to execute at least one other user interface view.

13. A computer software product, which comprises computer executable commands for displaying a user interface view, which user interface view comprises at least one link to another user interface view and for identifying a pointing towards said link, which link is arranged to execute a pop-up view in said user interface view and in addition to perform said other user interface view, wherein the commands executed by the computer are arranged to execute said pop-up view instead of displaying said other user interface view as well as to add to said pop-up view the link in question as a selectable function.

14. A method for displaying a user interface view, which user interface view comprises at least one link, in which method the pointing focused on the link is identified, which is arranged to execute a pop-up view in said user interface view and, in addition, execute said other user interface view, wherein in the method said pop-up view is executed instead of displaying said other user interface view and the link in question is added as a selectable function of said pop-up view.

15. The method according to claim 14, wherein the method is performed conditionally in such a manner that the need for opening a pop-up view is checked from the user or automatically, in which case the pop-up view is executed only if necessary.
